(19) United States
(12) Patent Application Publication
(10) Pub. No.: US 2004/0192517 A1
(43) Pub. Date: Sep. 30, 2004

(54) Assisting device to help baby or children to walk

(76) Inventor: Wen Bang Shiu, Chuang Hua (TW)

Correspondence Address: Wen Bang Shiu, P.O. Box 63-298, Taichung, 406, TW

(21) Appl. No.: 10/402,783

(22) Filed: Mar. 28, 2003

(51) Int. Cl. A61H 3/00; A47D 13/04

(52) U.S. Cl. 482/69

(57) ABSTRACT

A walk assisting device includes a longitudinal member made of such as woven or non-woven cloth materials to form a tubular structure, and having a cushioning middle portion for engaging onto chest portion of babies or children. A fastening belt may be attached to the cushioning middle portion of the longitudinal member, to secure the longitudinal member onto the chest portion of the babies or children. The ends of the longitudinal member may include one or more knots for being carried by the users. The longitudinal member may include two resilient side portions to attach onto the chest portions of babies or children of different chest measurements.

### BACKGROUND OF THE INVENTION

1. Field of the Invention

The present invention relates to a walk assisting device, and more particularly to a walk assisting device to help or to assist babies or children to walk.

2. Description of the Prior Art

Typically, for helping or assisting the babies or children to walk, the adults normally hold or pull the hands of the babies or children, to guide and to teach the babies or children to walk, and to prevent the babies or children from falling onto the ground.

However, the hands of the babies or children may be easily hurt by the adults inadvertently while helping or assisting the babies or children to walk, because the adults may have a good chance to apply a great force against the hands of the babies or children while helping or assisting the babies or children to walk.

In order to suitably help or assist the babies or children to walk, some typical walk assisting devices have been developed and comprise a strap or belt member to engage onto the babies or children, particularly to engage around the hip portion of the babies or children.

However, the hip portion of the babies or children may be easily scratched or scraped and hurt by the strap or belt member of the typical walk assisting device while helping or assisting the babies or children to walk.

The present invention has arisen to mitigate and/or obviate the afore-described disadvantages of the conventional walk assisting devices.

### SUMMARY OF THE INVENTION

The primary objective of the present invention is to provide a walk assisting device for helping or assisting babies or children to walk.

The other objective of the present invention is to provide a walk assisting device having a cushioning member to cushion the babies or children, and to protect the babies or children, or to prevent the babies or children from being hurt by the walk assisting device.

The further objective of the present invention is to provide a walk assisting device to protect the hip portions of the babies or children from being hurt by the walk assisting device.

In accordance with one aspect of the invention, there is provided a walk assisting device comprising a longitudinal member including a cushioning middle portion for engaging onto and for protecting chest portion of babies or children, and including a fastening belt attached to the cushioning middle portion of the longitudinal member, for securing the cushioning middle portion of the longitudinal member onto the chest portion of the babies or children, and the longitudinal member including two ends to be carried by users.

The longitudinal member includes at least one knot formed in the ends thereof to define at least one opening therein, for receiving hands of the users.

The longitudinal member includes two side portions each having a resilient strap member disposed therein, to form a retractable member and for allowing the longitudinal member to be adjustably engaged onto chest portions of babies or children of different chest measurements.

A pad may further be provided for engaging onto back portion of babies or children, and at least one shoulder band may further be provided and coupled between the pad and the longitudinal member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a walk assisting device in accordance with the present invention;

FIG. 2 is a perspective view illustrating the operation of the walk assisting device;

FIG. 3 is a partial side schematic view illustrating the operation of the walk assisting device;

FIG. 4 is a partial rear schematic view illustrating the operation of the walk assisting device;

FIG. 5 is a cross sectional view taken along lines 5-5 of GFIG. 3; and

FIG. 6 is a cross sectional view similar to FIG. 5, illustrating the operation of the walk assisting device.

### DETAILED DESCRIPTION OF THE PREFERRED EMBODIMENT

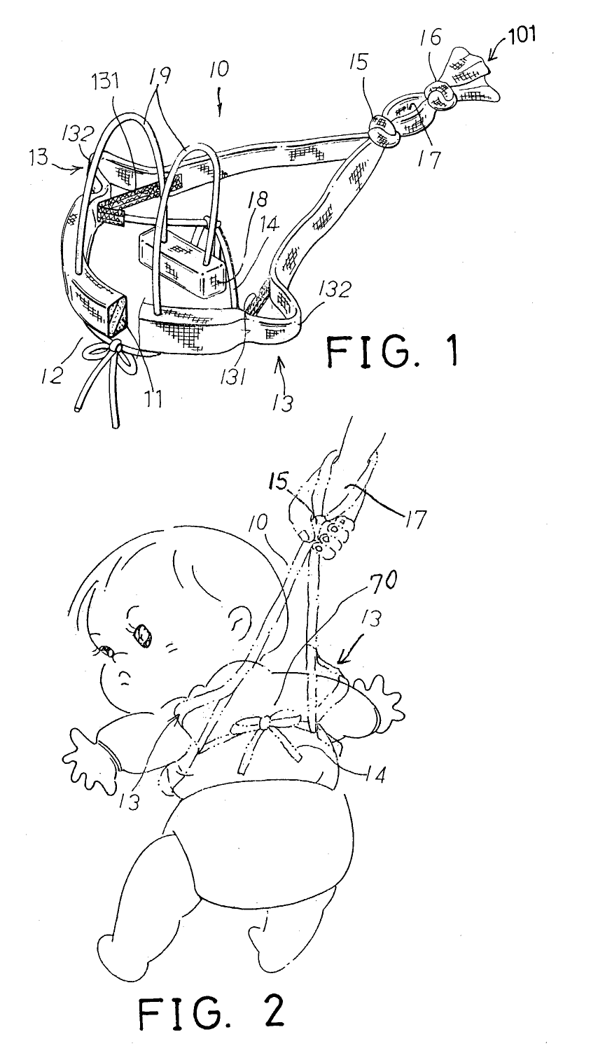

Referring to the drawings, and initially to FIGS. 1-5, a walk assisting device in accordance with the present invention comprises a longitudinal or tubular member 10 made of woven or non-woven cloth materials, a spongy or cushioning member 11 engaged into the middle portion 12 of the tubular member 10, to form a cushioning middle portion 12, and to engage onto the front or the chest portion of the babies or children 70 (FIGS. 2-6), and to cushion and protect the chest portion of the babies or children 70.

The tubular member 10 includes two side portions 13 each having a resilient strap member 131 disposed therein, to form or define a retractable or extendible or foldable member 132 (FIG. 6), for allowing the tubular member 10 to be suitably or adjustably or comfortably engaged onto the chest portions of the babies or children 70 that have different chest measurements.

The tubular member 10 further includes a fastening belt 14 attached to the ends of the middle portion 12 of the tubular member 10, or the two side portions 13 of the tubular member 10, for solidly attaching or securing the middle portion 12 of the tubular member 10 onto the chest portions of the babies or children 70 (FIGS. 2, and 4-6).

The tubular member 10 includes two end portions 101 that may be secured together to form one or more knots 15, 16, and to form one or more openings 17 between the knots 15, 16, for receiving the hands of the users or adults (FIG. 2), and for allowing the adults to hold or carry or pull the tubular member 10, and thus to guide and to teach or to help the babies or children to walk.

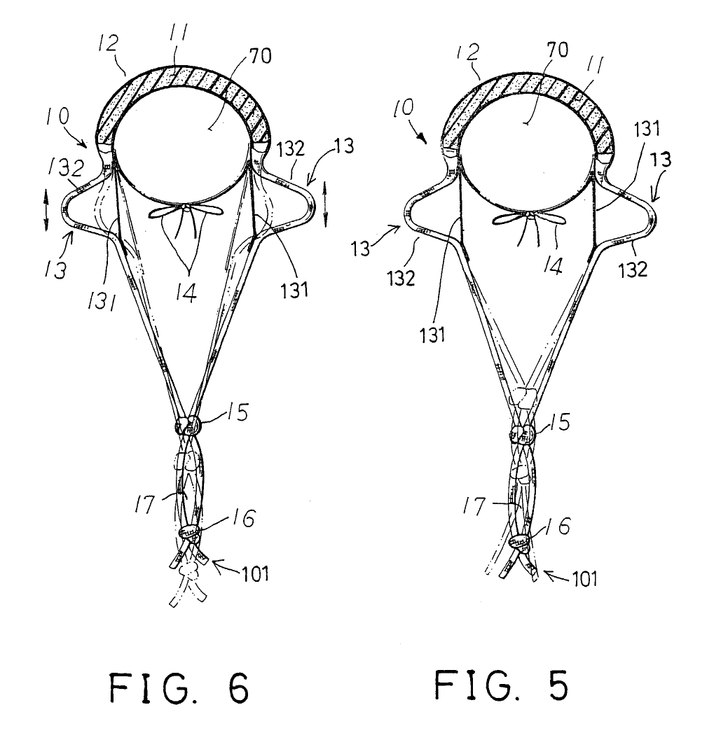

As shown in FIG. 5, the knots 15, 16 of the tubular member 10 may be formed or adjusted relative to the end portions 101 of the tubular member 10, for allowing the hands of the users or adults to engage into the opening 17 at different position of the tubular member 10, and thus for allowing the hands of the users or adults to hold or carry or pull the tubular member 10 at different position, so as to suitably and conveniently guide and help the babies or children to walk.

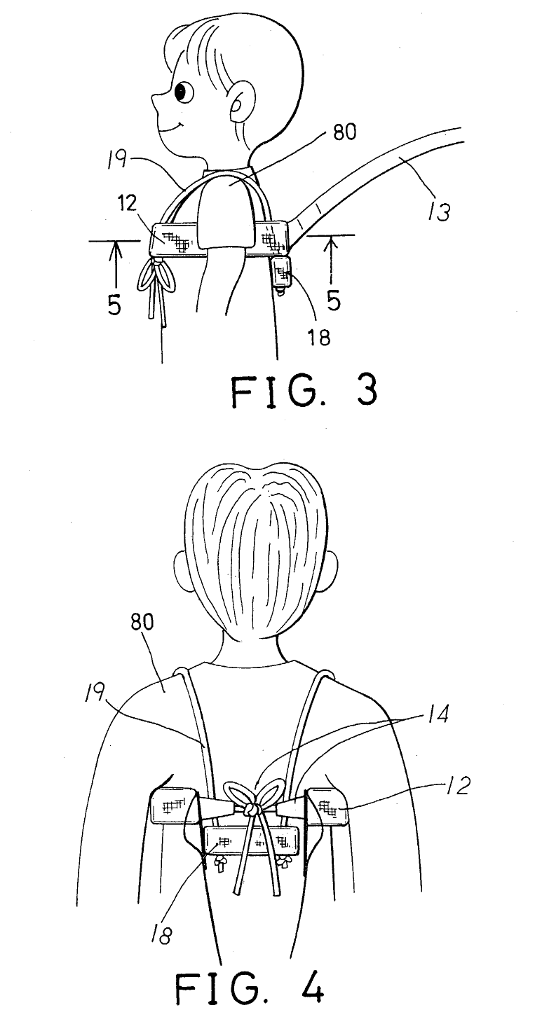

The tubular member 10 may further include a pad 18 for attaching onto the back portion of the babies or children 70 (FIGS. 3, 4), and one or more shoulder bands 19 couple the pad 18 to the tubular member 10, such as to the cushioning middle portion 12 of the tubular member 10, in order to engage onto the shoulder portions 80 of the babies or children 70, and to further solidly attach or secure the tubular member 10 onto the babies or children 70.

It is to be noted that the tubular member 10 is not required to be engaged onto or around the hip portions of the babies or children 70, and may thus be used to protect or to prevent the hip portions of the babies or children from being hurt by the walk assisting device. In addition, the walk assisting device includes one or more cushioning members 11, 18 to cushion the babies or children 70, and to protect the babies or children 70, or to further prevent the babies or children from being hurt by the walk assisting device.

Accordingly, the walk assisting device in accordance with the present invention may be provided for helping or assisting babies or children to walk, and may include a cushioning member to cushion the babies or children, and to protect the babies or children, or to prevent the babies or children from being hurt by the walk assisting device, and may be used to protect the hip portions of the babies or children from being hurt by the walk assisting device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A walk assisting device comprising:
a longitudinal member including a cushioning middle portion for engaging onto and for protecting chest portion of babies or children, and including a fastening belt attached to said cushioning middle portion of said longitudinal member, for securing said cushioning middle portion of said longitudinal member onto the chest portion of the babies or children, and
said longitudinal member including two ends to be carried by users.

2. The walk assisting device as claimed in claim 1, wherein said longitudinal member includes at least one knot formed in said ends thereof to define at least one opening therein, for receiving hands of the users.

3. The walk assisting device as claimed in claim 1, wherein said longitudinal member includes two side portions each having a resilient strap member disposed therein, to form a retractable member and for allowing said longitudinal member to be adjustably engaged onto chest portions of babies or children of different chest measurements.

4. The walk assisting device as claimed in claim 1 further comprising a pad for engaging onto back portion of babies or children, and at least one shoulder band coupled between said pad and said longitudinal member.

5. The walk assisting device as claimed in claim 1, wherein said longitudinal member is a tubular member formed with cloth materials.

6. A walk assisting device comprising:
a longitudinal member including a cushioning middle portion for engaging onto and for protecting chest portion of babies or children, and including two side portions each having a resilient strap member disposed therein, to form a retractable member and to allow said longitudinal member to be adjustably engaged onto chest portions of babies or children of different chest measurements, and
said longitudinal member including two ends to be carried by users.

7. The walk assisting device as claimed in claim 6, wherein said longitudinal member includes at least one knot formed in said ends thereof to define at least one opening therein, for receiving hands of the users.

8. The walk assisting device as claimed in claim 6, wherein said longitudinal member includes a fastening belt attached to said cushioning middle portion of said longitudinal member, for securing said cushioning middle portion of said longitudinal member onto the chest portion of the babies or children.

9. The walk assisting device as claimed in claim 6 further comprising a pad for engaging onto back portion of babies or children, and at least one shoulder band coupled between said pad and said longitudinal member.

10. The walk assisting device as claimed in claim 6, wherein said longitudinal member is a tubular member formed with cloth materials.

11. A walk assisting device comprising:
a longitudinal member including a cushioning middle portion for engaging onto and for protecting chest portion of babies or children, and
said longitudinal member including two ends, and including at least one knot formed in said ends thereof to define at least one opening therein, and to receive hands of users.

12. The walk assisting device as claimed in claim 11, wherein said longitudinal member includes two side portions each having a resilient strap member disposed therein, to form a retractable member and for allowing said longitudinal member to be adjustably engaged onto chest portions of babies or children of different chest measurements.

13. The walk assisting device as claimed in claim 11 further comprising a pad for engaging onto back portion of babies or children, and at least one shoulder band coupled between said pad and said longitudinal member.

14. The walk assisting device as claimed in claim 11, wherein said longitudinal member includes a fastening belt attached to said cushioning middle portion of said longitudinal member, for securing said cushioning middle portion of said longitudinal member onto the chest portion of the babies or children.

15. The walk assisting device as claimed in claim 11, wherein said longitudinal member is a tubular member formed with cloth materials.
